(19) United States
(12) Patent Application Publication
(10) Pub. No.: US 2007/0068149 A1
(43) Pub. Date: Mar. 29, 2007

(54) Air and fuel supply system for combustion engine with particulate trap

(76) Inventors: James R. Weber, Lacon, IL (US); Scott A. Leman, Eureka, IL (US); Gerald N. Coleman, Bulwick (GB); Kevin P. Duffy, Metamora, IL (US); Eric C. Fluga, Dunlap, IL (US); Jonathan P. Kilkenny, Peoria, IL (US); Cornelius P. Opris, Peoria, IL (US)

Correspondence Address: Finnegan, Henderson, Farabow;Garrett & Dunner, L.L.P., 901 New York Avenue, N.W., Washington, DC, 20005-3315, US

(21) Appl. No.: 11/509,082

(22) Filed: Aug. 24, 2006

Related U.S. Application Data
(63) Continuation of application No. 10/992,866, filed on Nov. 19, 2004, now abandoned.
Application No. 10/992,866 is a continuation-in-part of application No. 10/733,570, filed on Dec. 12, 2003, now abandoned.
Application No. 10/733,570 is a continuation of application No. 10/143,908, filed on May 14, 2002, now Pat. No. 6,688,280.
Application No. 10/992,866 is a continuation-in-part of application No. 10/933,300, filed on Sep. 3, 2004.
Application No. 10/933,300 is a continuation-in-part of application No. 10/733,570, filed on Dec. 12, 2003, now abandoned.
Application No. 10/733,570 is a continuation of application No. 10/143,908, filed on May 14, 2002, now Pat. No. 6,688,280.
Application No. 10/992,866 is a continuation-in-part of application No. 10/901,328, filed on Jul. 29, 2004.

(51) Int. Cl. F02B 27/02; F02B 75/02; F02B 33/44

(52) U.S. Cl. 60/312; 123/316; 60/605.2

(57) ABSTRACT

An engine and method of operating an internal combustion engine is provided. The method comprises supplying pressurized air from an intake manifold to an air intake port of a combustion chamber in the cylinder, operating an air intake valve to open the air intake port to allow the pressurized air to flow between the combustion chamber and the intake manifold during a portion of a compression stroke of the piston, and filtering particulate matter from an exhaust stream of the engine with a particulate filter.

This application is a continuation-in-part of application Ser. No. 10/733,570, filed Dec. 12, 2003, which is a continuation of application Ser. No. 10/143,908, filed May 14, 2002, now U.S. Pat. No. 6,688,280; this application is also a continuation-in-part of application Ser. No. 10/933,300, filed Sep. 3, 2004, which is a continuation-in-part of application Ser. No. 10/733,570, filed Dec. 12, 2003, which is a continuation of application Ser. No. 10/143,908, filed May 14, 2002, which is now U.S. Pat. No. 6,688,280; this application is also a continuation-in-part of application Ser. No. 10/901,328, filed Jul. 29, 2004; the content of all of the above are hereby incorporated by reference.

### TECHNICAL FIELD

The present description relates to a combustion engine and, more particularly, to an air and fuel supply system for use with an engine having an exhaust treatment system with particulate filters.

### BACKGROUND

Internal combustion engines, including diesel engines, gasoline engines, natural gas engines, and other engines known in the art, may exhaust a complex mixture of air pollutants. The air pollutants may be composed of gaseous compounds, which may include nitrous oxides (“NOₓ”), and solid particulate matter, which may include unburned carbon particulates called soot.

Due to increased attention on the environment, exhaust emission standards have become more stringent, and the amount of gaseous compounds emitted to the atmosphere from an engine may be regulated depending on the type of engine, size of engine, and/or class of engine. One method that has been implemented by engine manufacturers to comply with the regulation of these engine emissions is exhaust gas recirculation (“EGR”). EGR systems recirculate the exhaust gas byproducts into the intake air supply of the internal combustion engine. The exhaust gas, which is directed to the engine cylinder, reduces the concentration of oxygen within the cylinder, which in turn lowers the maximum combustion temperature within the cylinder. The lowered maximum combustion temperature can slow the chemical reaction of the combustion process and decrease the formation of NOx.

In many EGR applications, the exhaust gas is diverted directly from the exhaust manifold by an EGR valve. However, the particulate matter in the recirculated exhaust gas can adversely affect the performance and durability of the internal combustion engine and EGR system. As disclosed in U.S. Pat. No. 6,526,753 (“the '753 patent”), issued to Bailey on Mar. 3, 2003, a filter can be used to remove particulate matter from the exhaust gas that is being fed back to the intake air stream for recirculation. Specifically, the '753 patent discloses an exhaust gas regenerator/particulate capture system that includes a first particulate filter and a second particulate filter. A regenerator valve operates between a first position where an EGR inlet port fluidly connects a portion of an exhaust flow with the first particulate filter and a second position where the EGR inlet port fluidly connects the portion of the exhaust flow with the second particulate filter. The filtered EGR gases are then supplied for mixing with compressed air prior to or during entry into the intake manifold.

Although the exhaust gas regenerator/particulate capture system of the '753 patent may protect the engine from harmful particulate matter, it may be complex and difficult to package. For example, because the exhaust gas regenerator/particulate capture system of the '753 patent must alternate exhaust flow between the first and second particulate filters to avoid clogging, additional piping, valving, and control strategies may be required. These additional components coupled with the space required to mount and house the components within the engine compartment can increase the cost of the exhaust gas regenerator/particulate capture system and the difficulty of retrofitting the exhaust gas regenerator/particulate capture system to older vehicles. In addition, the portion of the exhaust gas not flowing through the exhaust gas regenerator/particulate capture system of the '753 patent may be completely unfiltered and untreated.

Additionally, either early or late closing of the intake valve, referred to as the “Miller Cycle,” may reduce the effective compression ratio of the cylinder, which in turn reduces compression temperature, while maintaining a high expansion ratio. Consequently, a Miller cycle engine may have improved thermal efficiency and reduced exhaust emissions of, for example, NOₓ. In a conventional Miller cycle engine, the timing of the intake valve close is typically shifted slightly forward or backward from that of the typical Otto cycle engine. For example, in the Miller cycle engine, the intake valve may remain open until the beginning of the compression stroke.

To ensure that enough air is entering the combustion chamber, the engine may include one or more turbochargers for boosting the intake manifold pressure for supplying air to one or more combustion chambers within corresponding combustion cylinders. Each turbocharger typically includes a turbine driven by exhaust gases of the engine and a compressor driven by the turbine.

An internal combustion engine may also include a supercharger arranged in series with a turbocharger compressor of an engine. U.S. Pat. No. 6,273,076, issued to Beck et al. on Aug. 14, 2001 discloses a supercharger having a turbine that drives a compressor to increase the pressure of air flowing to a turbocharger compressor of an engine. In some situations, the air charge temperature may be reduced below ambient air temperature by an early closing of the intake valve.

While a turbocharger may utilize some energy from the engine exhaust, the series supercharger/turbocharger arrangement does not utilize energy from the turbocharger exhaust Furthermore, the supercharger requires an additional energy source.

The present description is directed to overcoming one or more of the problems as set forth above.

### SUMMARY

According to one aspect, a method of operating an internal combustion engine, including at least one cylinder and a piston slidable in the cylinder, is provided. The method comprises supplying pressurized air from an intake manifold to an air intake port of a combustion chamber in the cylinder, operating an air intake valve to open the air intake port to allow the pressurized air to flow between the combustion chamber and the intake manifold during a portion of a compression stroke of the piston, and filtering particulate matter from an exhaust stream of the engine with a particulate filter.

In some embodiments, a mixture of pressurized air and recirculated exhaust gas from may be supplied from an intake manifold to an air intake port of a combustion chamber.

It is to be understood that both the foregoing general description and the following detailed description are explanatory only and are not restrictive.

### BRIEF DESCRIPTION OF THE DRAWINGS

The accompanying drawings, which are incorporated in and constitute a part of this specification, illustrate several embodiments and, together with the description, serve to explain the principles of the description. In the drawings,

FIG. 1 is a combination diagrammatic and schematic illustration of an air supply system for an internal combustion engine in accordance with the description;

FIG. 2 is a combination diagrammatic and schematic illustration of an engine cylinder in accordance with the description;

FIG. 3 is a diagrammatic sectional view of the engine cylinder of FIG. 2;

FIG. 4 is a graph illustrating an intake valve actuation as a function of engine crank angle in accordance with the present description;

FIG. 5 is a graph illustrating an fuel injection as a function of engine crank angle in accordance with the present description;

FIG. 6 is a combination diagrammatic and schematic illustration of another air supply system for an internal combustion engine in accordance with the description;

FIG. 7 is a combination diagrammatic and schematic illustration of yet another air supply system for an internal combustion engine;

FIG. 8 is a combination diagrammatic and schematic illustration of an exhaust gas recirculation system included as part of an internal combustion engine; and

FIG. 9 is a diagrammatic illustration of an engine having an exhaust treatment system according to a disclosed embodiment.

### DETAILED DESCRIPTION

Reference will now be made in detail to embodiments of the description, examples of which are illustrated in the accompanying drawings. Wherever possible, the same reference numbers will be used throughout the drawings to refer to the same or like parts.

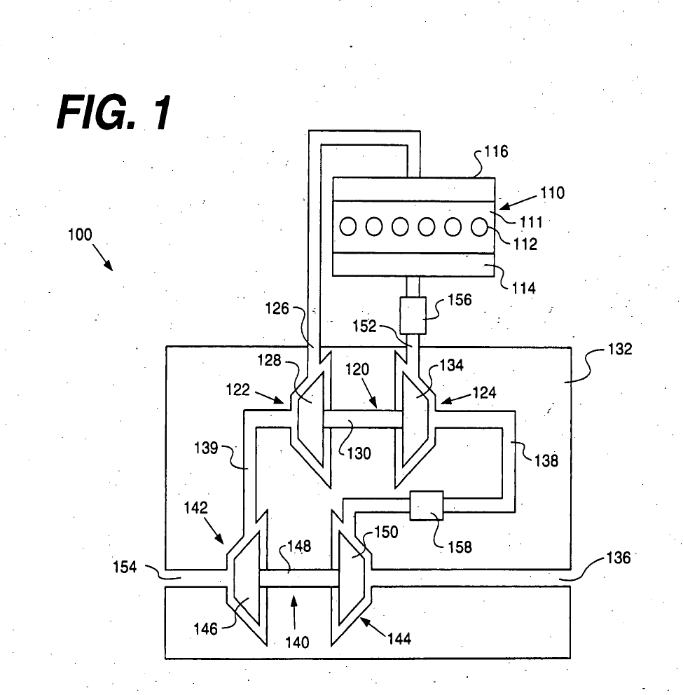

Referring to FIG. 1, an air supply system 100 for an internal combustion engine 110, for example, a four-stroke, diesel engine, is provided. The internal combustion engine 110 includes an engine block 111 defining a plurality of combustion cylinders 112, the number of which depends upon the particular application. For example, a 4-cylinder engine would include four combustion cylinders, a 6-cylinder engine would include six combustion cylinders, etc. In the embodiment of FIG. 1, six combustion cylinders 112 are shown. It should be appreciated that the engine 110 may be any other type of internal combustion engine, for example, a gasoline or natural gas engine.

The internal combustion engine 110 also includes an intake manifold 114 and an exhaust manifold 116. The intake manifold 114 provides fluid, for example, air or a fuel/air mixture, to the combustion cylinders 112. The exhaust manifold 116 receives exhaust fluid, for example, exhaust gas, from the combustion cylinders 112. The intake manifold 114 and the exhaust manifold 116 are shown as a single-part construction for simplicity in the drawing. However, it should be appreciated that the intake manifold 114 and/or the exhaust manifold 116 may be constructed as multi-part manifolds, depending upon the particular application.

The air supply system 100 includes a first turbocharger 120 and may include a second turbocharger 140. The first and second turbochargers 120, 140 may be arranged in series with one another such that the second turbocharger 140 provides a first stage of pressurization and the first turbocharger 120 provides a second stage of pressurization. For example, the second turbocharger 140 may be a low pressure turbocharger and the first turbocharger 120 may be a high pressure turbocharger. The first turbocharger 120 includes a turbine 122 and a compressor 124. The turbine 122 is fluidly connected to the exhaust manifold 116 via an exhaust duct 126. The turbine 122 includes a turbine wheel 128 carried by a shaft 130, which in turn may be rotatably carried by a housing 132, for example, a single-part or multi-part housing. The fluid flow path from the exhaust manifold 116 to the turbine 122 may include a variable nozzle (not shown) or other variable geometry arrangement adapted to control the velocity of exhaust fluid impinging on the turbine wheel 128.

The compressor 124 includes a compressor wheel 134 carried by the shaft 130. Thus, rotation of the shaft 130 by the turbine wheel 128 in turn may cause rotation of the compressor wheel 134.

The first turbocharger 120 may include a compressed air duct 138 for receiving compressed air from the second turbocharger 140 and an air outlet line 152 for receiving compressed air from the compressor 124 and supplying the compressed air to the intake manifold 114 of the engine 110. The first turbocharger 120 may also include an exhaust duct 139 for receiving exhaust fluid from the turbine 122 and supplying the exhaust fluid to the second turbocharger 140.

The second turbocharger 140 may include a turbine 142 and a compressor 144. The turbine 142 may be fluidly connected to the exhaust duct 139. The turbine 142 may include a turbine wheel 146 carried by a shaft 148, which in turn may be rotatably carried by the housing 132. The compressor 144 may include a compressor wheel 150 carried by the shaft 148. Thus, rotation of the shaft 148 by the turbine wheel 146 may in turn cause rotation of the compressor wheel 150.

The second turbocharger 140 may include an air intake line 136 providing fluid communication between the atmosphere and the compressor 144. The second turbocharger 140 may also supply compressed air to the first turbocharger 120 via the compressed air duct 138. The second turbocharger 140 may include an exhaust outlet 154 for receiving exhaust fluid from the turbine 142 and providing fluid communication with the atmosphere. In an embodiment, the first turbocharger 120 and second turbocharger 140 may be sized to provide substantially similar compression ratios. For example, the first turbocharger 120 and second turbocharger 140 may both provide compression ratios of between 2 to 1 and 3 to 1, resulting in a system compression ratio of at least 4:1 with respect to atmospheric pressure. Alternatively, the second turbocharger 140 may provide a compression ratio of 3 to 1 and the first turbocharger 120 may provide a compression ratio of 1.5 to 1, resulting in a system compression ratio of 4.5 to 1 with respect to atmospheric pressure.

The air supply system 100 may include an air cooler 156, for example, an aftercooler, between the compressor 124 and the intake manifold 114. The air cooler 156 may extract heat from the air to lower the intake manifold temperature and increase the air density. Optionally, the air supply system 100 may include an additional air cooler 158, for example, an intercooler, between the compressor 144 of the second turbocharger 140 and the compressor 124 of the first turbocharger 120. Intercooling may use techniques such as jacket water, air to air, and the like. Alternatively, the air supply system 100 may optionally include an additional air cooler (not shown) between the air cooler 156 and the intake manifold 114. The optional additional air cooler may further reduce the intake manifold temperature. A jacket water pre-cooler (not shown) may be used to protect the air cooler 156.

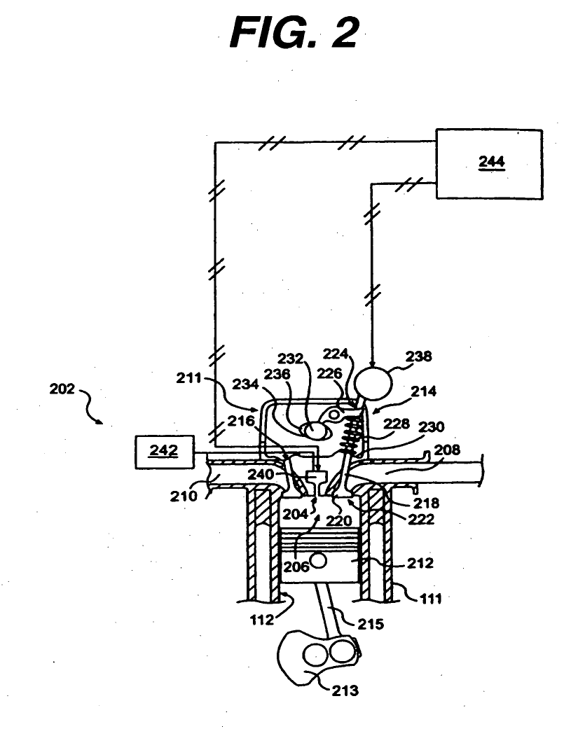

Referring now to FIG. 2, a cylinder head 211 may be connected with the engine block 111. Each cylinder 112 in the cylinder head 211 may be provided with a fuel supply system 202. The fuel supply system 202 may include a fuel port 204 opening to a combustion chamber 206 within the cylinder 112. The fuel supply system 202 may inject fuel, for example, diesel fuel, directly into the combustion chamber 206.

The cylinder 112 may contain a piston 212 slidably movable in the cylinder. A crankshaft 213 may be rotatably disposed within the engine block 111. A connecting rod 215 may couple the piston 212 to the crankshaft 213 so that sliding motion of the piston 212 within the cylinder 112 results in rotation of the crankshaft 213. Similarly, rotation of the crankshaft 213 results in a sliding motion of the piston 212. For example, an uppermost position of the piston 212 in the cylinder 112 corresponds to a top dead center position of the crankshaft 213, and a lowermost position of the piston 212 in the cylinder 112 corresponds to a bottom dead center position of the crankshaft 213.

As one skilled in the art will recognize, the piston 212 in a conventional, four-stroke engine cycle reciprocates between the uppermost position and the lowermost position during a combustion (or expansion) stroke, an exhaust stroke, and intake stroke, and a compression stroke. Meanwhile, the crankshaft 213 rotates from the top dead center position to the bottom dead center position during the combustion stroke, from the bottom dead center to the top dead center during the exhaust stroke, from top dead center to bottom dead center during the intake stroke, and from bottom dead center to top dead center during the compression stroke. Then, the four-stroke cycle begins again. Each piston stroke correlates to about 180° of crankshaft rotation, or crank angle. Thus, the combustion stroke may begin at about 0° crank angle, the exhaust stroke at about 180°, the intake stroke at about 360°, and the compression stroke at about 540°.

The cylinder 112 may include at least one intake port 208 and at least one exhaust port 210, each opening to the combustion chamber 206. The intake port 208 may be opened and closed by an intake valve assembly 214, and the exhaust port 210 may be opened and closed by an exhaust valve assembly 216. The intake valve assembly 214 may include, for example, an intake valve 218 having a head 220 at a first end 222, with the head 220 being sized and arranged to selectively close the intake port 208. The second end 224 of the intake valve 218 may be connected to a rocker arm 226 or any other conventional valve-actuating mechanism. The intake valve 218 may be movable between a first position permitting flow from the intake manifold 114 to enter the combustion cylinder 112 and a second position substantially blocking flow from the intake manifold 114 to the combustion cylinder 112. A spring 228 may be disposed about the intake valve 218 to bias the intake valve 218 to the second, closed position.

A camshaft 232 carrying a cam 234 with one or more lobes 236 may be arranged to operate the intake valve assembly 214 cyclically based on the configuration of the cam 234, the lobes 236, and the rotation of the camshaft 232 to achieve a desired intake valve timing. The exhaust valve assembly 216 may be configured in a manner similar to the intake valve assembly 214 and may be operated by one of the lobes 236 of the cam 234. In an embodiment, the intake lobe 236 may be configured to operate the intake valve 218 in a conventional Otto or diesel cycle, whereby the intake valve 218 moves to the second position from between about 10° before bottom dead center of the intake stroke and about 10° after bottom dead center of the compression stroke. Alternatively, the intake valve assembly 214 and/or the exhaust valve assembly 216 may be operated hydraulically, pneumatically, electronically, or by any combination of mechanics, hydraulics, pneumatics, and/or electronics.

The intake valve assembly 214 may include a variable intake valve closing mechanism 238 structured and arranged to selectively interrupt cyclical movement of and extend the closing timing of the intake valve 218. The variable intake valve closing mechanism 238 may be operated hydraulically, pneumatically, electronically, mechanically, or any combination thereof. For example, the variable intake valve closing mechanism 238 may be selectively operated to supply hydraulic fluid, for example, at a low pressure or a high pressure, in a manner to resist closing of the intake valve 218 by the bias of the spring 228. That is, after the intake valve 218 is lifted, i.e., opened, by the cam 234, and when the cam 234 is no longer holding the intake valve 218 open, the hydraulic fluid may hold the intake valve 218 open for a desired period. The desired period may change depending on the desired performance of the engine 110. Thus, the variable intake valve closing mechanism 238 enables the engine 110 to operate under a conventional Otto or diesel cycle or under a variable late-closing Miller cycle.

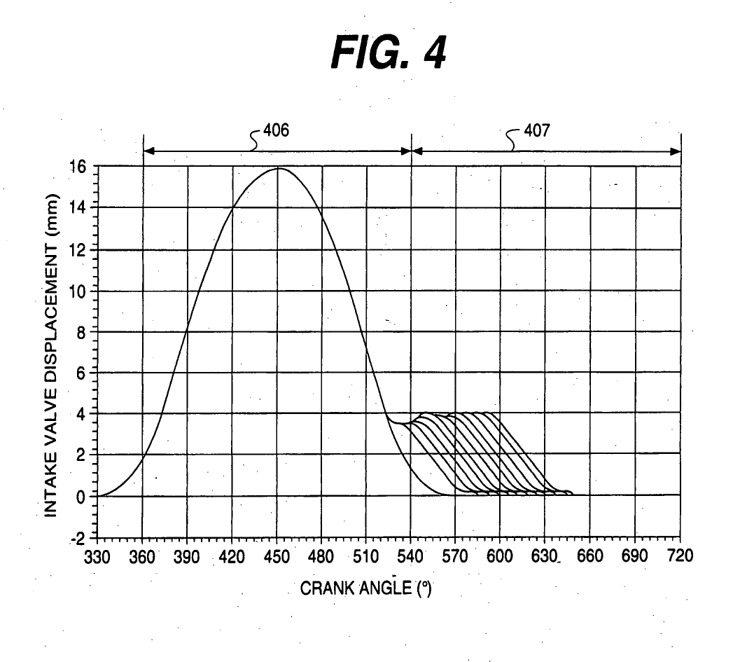

As shown in FIG. 4, the intake valve 218 may begin to open at about 360° crank angle, that is, when the crankshaft 213 is at or near a top dead center position of an intake stroke 406. The closing of the intake valve 218 may be selectively varied from about 540° crank angle, that is, when the crank shaft is at or near a bottom dead center position of a compression stroke 407, to about 650° crank angle, that is, about 70° before top center of the combustion stroke 508. Thus, the intake valve 218 may be held open for a majority portion of the compression stroke 407, that is, for the first half of the compression stroke 407 and a portion of the second half of the compression stroke 407.

The fuel supply system 202 may include a fuel injector assembly 240, for example, a mechanically-actuated, electronically-controlled unit injector, in fluid communication with a common fuel rail 242. Alternatively, the fuel injector assembly 240 may be any common rail type injector and may be actuated and/or operated hydraulically, mechanically, electrically, piezo-electrically, or any combination thereof. The common fuel rail 242 provides fuel to the fuel injector assembly 240 associated with each cylinder 112. The fuel injector assembly 240 may inject or otherwise spray fuel into the cylinder 112 via the fuel port 204 in accordance with a desired timing.

A controller 244 may be electrically connected to the variable intake valve closing mechanism 238 and/or the fuel injector assembly 240. The controller 244 may be configured to control operation of the variable intake valve closing mechanism 238 and/or the fuel injector assembly 240 based on one or more engine conditions, for example, engine speed, load, pressure, and/or temperature in order to achieve a desired engine performance. It should be appreciated that the functions of the controller 244 may be performed by a single controller or by a plurality of controllers. Similarly, spark timing in a natural gas engine may provide a similar function to fuel injector timing of a compression ignition engine.

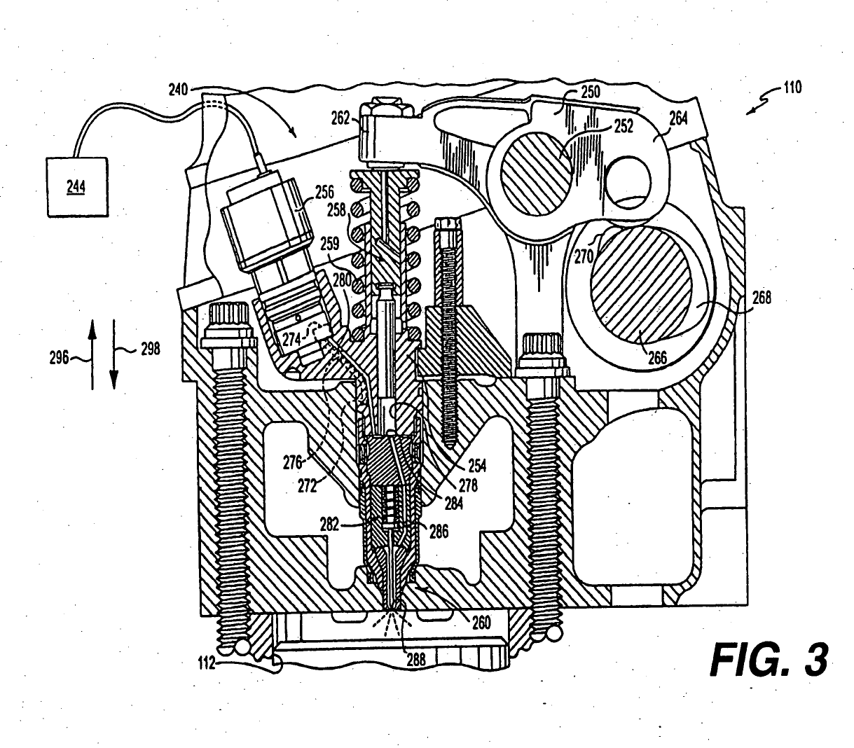

Referring now to FIG. 3, each fuel injector assembly 240 may be associated with an injector rocker arm 250 pivotally coupled to a rocker shaft 252. Each fuel injector assembly 240 may include an injector body 254, a solenoid 256, a plunger assembly 258, and an injector tip assembly 260. A first end 262 of the injector rocker arm 250 may be operatively coupled to the plunger assembly 258. The plunger assembly 258 may be biased by a spring 259 toward the first end 262 of the injector rocker arm 250 in the general direction of arrow 296.

A second end 264 of the injector rocker arm 250 may be operatively coupled to a camshaft 266. More specifically, the camshaft 266 may include a cam lobe 267 having a first bump 268 and a second bump 270. The camshafts 232, 266 and their respective lobes 236, 267 may be combined into a single camshaft (not shown) if desired. The bumps 268, 270 may be moved into and out of contact with the second end 264 of the injector rocker arm 250 during rotation of the camshaft 266. The bumps 268, 270 may be structured and arranged such that the second bump 270 may provide a pilot injection of fuel at a predetermined crank angle before the first bump 268 provides a main injection of fuel. It should be appreciated that the cam lobe 267 may have only a first bump 268 that injects all of the fuel per cycle.

When one of the bumps 268, 270 is rotated into contact with the injector rocker arm 250, the second end 264 of the injector rocker arm 250 is urged in the general direction of arrow 296. As the second end 264 is urged in the general direction of arrow 296, the rocker arm 250 pivots about the rocker shaft 252 thereby causing the first end 262 to be urged in the general direction of arrow 298. The force exerted on the second end 264 by the bumps 268, 270 is greater in magnitude than the bias generated by the spring 259, thereby causing the plunger assembly 258 to be likewise urged in the general direction of arrow 298. When the camshaft 266 is rotated beyond the maximum height of the bumps 268, 270, the bias of the spring 259 urges the plunger assembly 258 in the general direction of arrow 296. As the plunger assembly 258 is urged in the general direction of arrow 296, the first end 262 of the injector rocker arm 250 is likewise urged in the general direction of arrow 296, which causes the injector rocker arm 250 to pivot about the rocker shaft 252 thereby causing the second end 264 to be urged in the general direction of arrow 298.

The injector body 254 defines a fuel port 272. Fuel, such as diesel fuel, may be drawn or otherwise aspirated into the fuel port 272 from the fuel rail 242 when the plunger assembly 258 is moved in the general direction of arrow 296. The fuel port 272 is in fluid communication with a fuel valve 274 via a first fuel channel 276. The fuel valve 274 is, in turn in fluid communication with a plunger chamber 278 via a second fuel channel 280.

The solenoid 256 may be electrically coupled to the controller 244 and mechanically coupled to the fuel valve 274. Actuation of the solenoid 256 by a signal from the controller 244 may cause the fuel valve 274 to be switched from an open position to a closed position. When the fuel valve 274 is positioned in its open position, fuel may advance from the fuel port 272 to the plunger chamber 278, and vice versa. However, when the fuel valve 274 is positioned in its closed positioned, the fuel port 272 is isolated from the plunger chamber 278.

The injector tip assembly 260 may include a check valve assembly 282. Fuel may be advanced from the plunger chamber 278, through an inlet orifice 284, a third fuel channel 286, an outlet orifice 288, and into the cylinder 112 of the engine 110.

Thus, it should be appreciated that when one of the bumps 268, 270 is not in contact with the injector rocker arm 16, the plunger assembly 258 is urged in the general direction of arrow 296 by the spring 259 thereby causing fuel to be drawn into the fuel port 272 which in turn fills the plunger chamber 278 with fuel. As the camshaft 266 is further rotated, one of the bumps 268, 270 is moved into contact with the rocker arm 250, thereby causing the plunger assembly 258 to be urged in the general direction of arrow 298. If the controller 244 is not generating an injection signal, the fuel valve 274 remains in its open position, thereby causing the fuel that is in the plunger chamber 278 to be displaced by the plunger assembly 258 through the fuel port 272. However, if the controller 244 is generating an injection signal, the fuel valve 274 is positioned in its closed position thereby isolating the plunger chamber 278 from the fuel port 272. As the plunger assembly 258 continues to be urged in the general direction of arrow 298 by the camshaft 266, fluid pressure within the fuel injector assembly 240 increases. At a predetermined pressure magnitude, for example, at about 5500 psi (38 MPa), fuel is injected into the cylinder 112. Fuel will continue to be injected into the cylinder 112 until the controller 244 signals the solenoid 256 to return the fuel valve 274 to its open position.

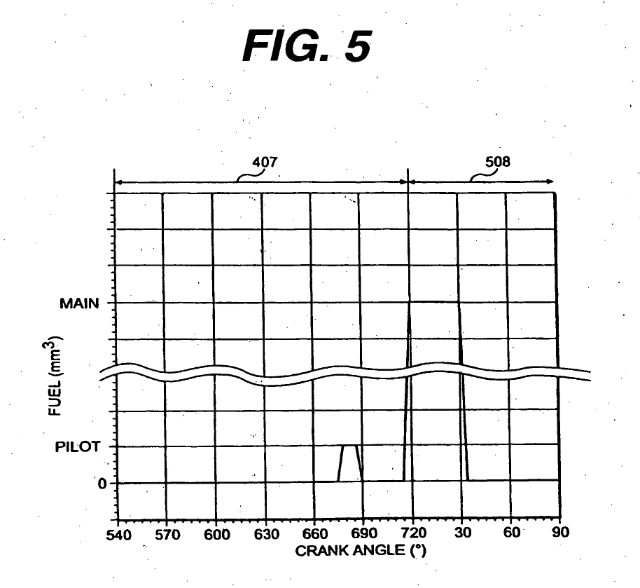

As shown in the graph of FIG. 5, the pilot injection of fuel may commence when the crankshaft 213 is at about 675° crank angle, that is, about 45° before top dead center of the compression stroke 407. The main injection of fuel may occur when the crankshaft 213 is at about 710° crank angle, that is, about 10° before top dead center of the compression stroke 407 and about 45° after commencement of the pilot injection. Generally, the pilot injection may commence when the crankshaft 213 is about 40-50° before top dead center of the compression stroke 407 and may last for about 10-15° crankshaft rotation. The main injection may commence when the crankshaft 213 is between about 10° before top dead center of the compression stroke 407 and about 12° after top dead center of the combustion stroke 508. The main injection may last for about 20-45° crankshaft rotation. The pilot injection may use a desired portion of the total fuel used, for example about 10%.

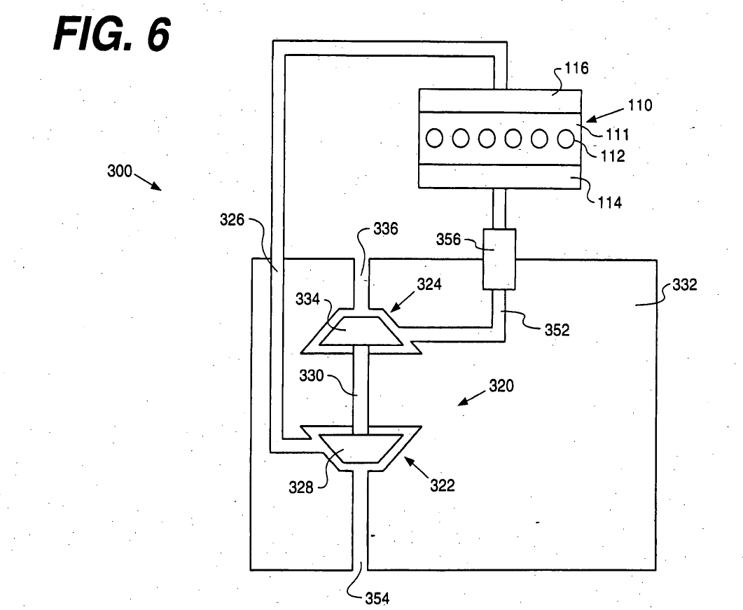

FIG. 6 is a combination diagrammatic and schematic illustration of a second air supply system 300 for the internal combustion engine 110. The air supply system 300 may include a turbocharger 320, for example, a high-efficiency turbocharger capable of producing at least about a 4 to 1 compression ratio with respect to atmospheric pressure. The turbocharger 320 may include a turbine 322 and a compressor 324. The turbine 322 may be fluidly connected to the exhaust manifold 116 via an exhaust duct 326. The turbine 322 may include a turbine wheel 328 carried by a shaft 330, which in turn may be rotatably carried by a housing 332, for example, a single-part or multi-part housing. The fluid flow path from the exhaust manifold 116 to the turbine 322 may include a variable nozzle (not shown), which may control the velocity of exhaust fluid impinging on the turbine wheel 328.

The compressor 324 may include a compressor wheel 334 carried by the shaft 330. Thus, rotation of the shaft 330 by the turbine wheel 328 in turn may cause rotation of the compressor wheel 334. The turbocharger 320 may include an air inlet 336 providing fluid communication between the atmosphere and the compressor 324 and an air outlet 352 for supplying compressed air to the intake manifold 114 of the engine 110. The turbocharger 320 may also include an exhaust outlet 354 for receiving exhaust fluid from the turbine 322 and providing fluid communication with the atmosphere.

The air supply system 300 may include an air cooler 356 between the compressor 324 and the intake manifold 114. Optionally, the air supply system 300 may include an additional air cooler (not shown) between the air cooler 356 and the intake manifold 114.

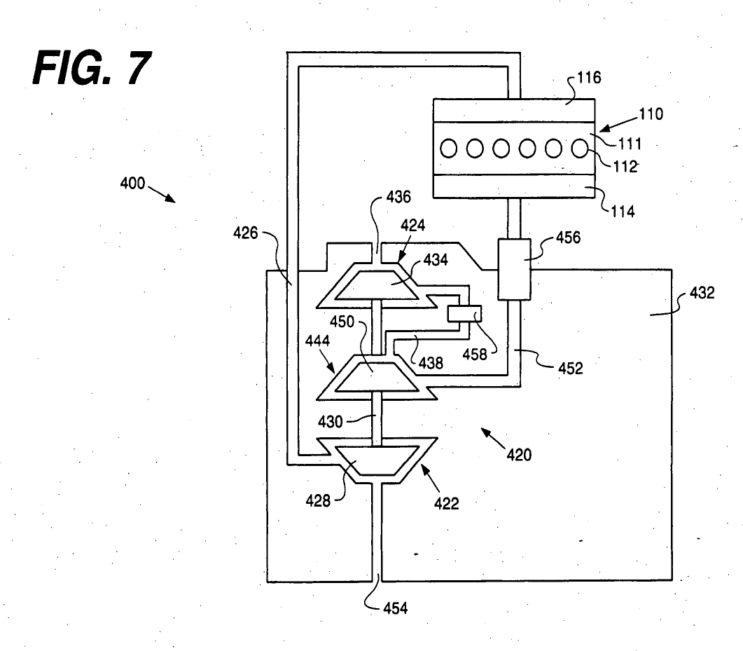

FIG. 7 is a combination diagrammatic and schematic illustration of a third air supply system 400 for the internal combustion engine 110. The air supply system 400 may include a turbocharger 420, for example, a turbocharger 420 having a turbine 422 and two compressors 424, 444. The turbine 422 may be fluidly connected to the exhaust manifold 116 via an inlet duct 426. The turbine 422 may include a turbine wheel 428 carried by a shaft 430, which in turn may be rotatably carried by a housing 432, for example, a single-part or multi-part housing. The fluid flow path from the exhaust manifold 116 to the turbine 422 may include a variable nozzle (not shown), which may control the velocity of exhaust fluid impinging on the turbine wheel 428.

The first compressor 424 may include a compressor wheel 434 carried by the shaft 430, and the second compressor 444 may include a compressor wheel 450 carried by the shaft 430. Thus, rotation of the shaft 430 by the turbine wheel 428 in turn may cause rotation of the first and second compressor wheels 434, 450. The first and second compressors 424, 444 may provide first and second stages of pressurization, respectively.

The turbocharger 420 may include an air intake line 436 providing fluid communication between the atmosphere and the first compressor 424 and a compressed air duct 438 for receiving compressed air from the first compressor 424 and supplying the compressed air to the second compressor 444. The turbocharger 420 may include an air outlet line 452 for supplying compressed air from the second compressor 444 to the intake manifold 114 of the engine 110. The turbocharger 420 may also include an exhaust outlet 454 for receiving exhaust fluid from the turbine 422 and providing fluid communication with the atmosphere.

For example, the first compressor 424 and second compressor 444 may both provide compression ratios of between 2 to 1 and 3 to 1, resulting in a system compression ratio of at least 4:1 with respect to atmospheric pressure. Alternatively, the second compressor 444 may provide a compression ratio of 3 to 1 and the first compressor 424 may provide a compression ratio of 1.5 to 1, resulting in a system compression ratio of 4.5 to 1 with respect to atmospheric pressure.

The air supply system 400 may include an air cooler 456 between the compressor 424 and the intake manifold 114. Optionally, the air supply system 400 may include an additional air cooler 458 between the first compressor 424 and the second compressor 444 of the turbocharger 420. Alternatively, the air supply system 400 may optionally include an additional air cooler (not shown) between the air cooler 456 and the intake manifold 114.

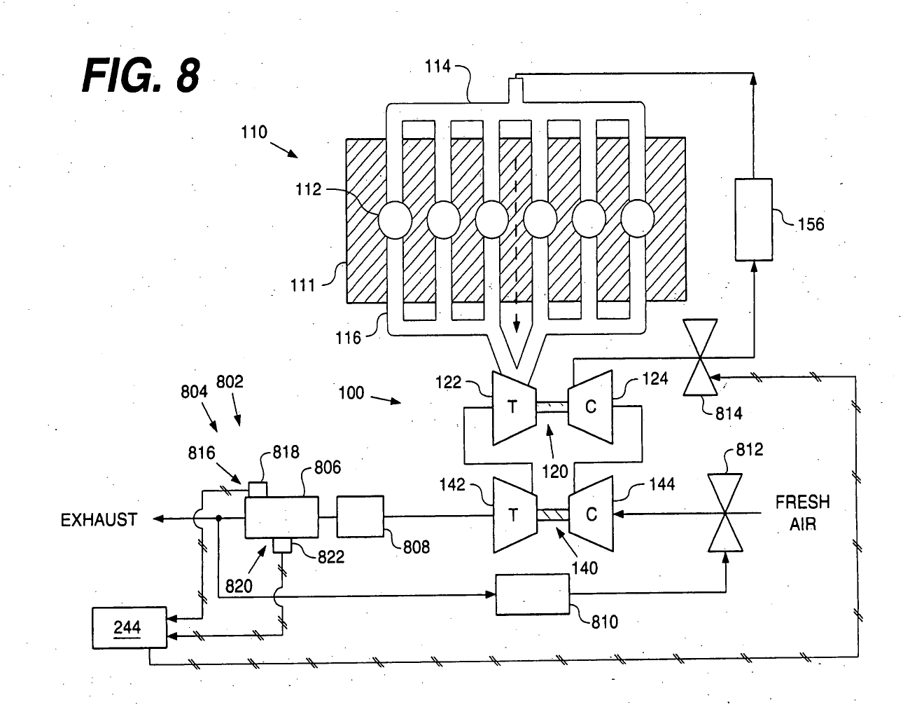

Referring to FIG. 8, an exhaust gas recirculation (“EGR”) system 804 in an exhaust system 802 in a combustion engine 110 is shown. Combustion engine 110 includes intake manifold 114 and exhaust manifold 116. Engine block 111 provides housing for at least one cylinder 112. FIG. 8 depicts six cylinders 112. However, any number of cylinders 112 could be used, for example, three, six, eight, ten, twelve, or any other number. The intake manifold 114 provides an intake path for each cylinder 112 for air, recirculated exhaust gases, or a combination thereof. The exhaust manifold 116 provides an exhaust path for each cylinder 112 for exhaust gases.

In the embodiment shown in FIG. 8, the air supply system 100 is shown as a two-stage turbocharger system. Air supply system 100 includes first turbocharger 120 having turbine 122 and compressor 124. Air supply system 100 also includes second turbocharger 140 having turbine 142 and compressor 144. The two-stage turbocharger system operates to increase the pressure of the air and exhaust gases being delivered to the cylinders 112 via intake manifold 114, and to maintain a desired air to fuel ratio during extended open durations of intake valves. It is noted that a two-stage turbocharger system is not required for operation. Other types of turbocharger systems, such as a high pressure ratio single-stage turbocharger system, a variable geometry turbocharger system, and the like, may be used instead.

A throttle valve 814, located between compressor 124 and intake manifold 114, may be used to control the amount of air and recirculated exhaust gases being delivered to the cylinders 112. The throttle valve 814 is shown between compressor 124 and an aftercooler 156. However, the throttle valve 814 may be positioned at other locations, such as after aftercooler 156. Operation of the throttle valve 814 is described in more detail below.

The EGR system 804 shown in FIG. 8 is typical of a low pressure EGR system in an internal combustion engine. Variations of the EGR system 804 may be equally used, including both low pressure loop and high pressure loop EGR systems. Other types of EGR systems, such as for example by-pass, venturi, piston-pumped, peak clipping, and back pressure, could be used.

An oxidation catalyst 808 receives exhaust gases from turbine 142, and serves to reduce HC emissions. The oxidation catalyst 808 may also be coupled with a De—NOₓ catalyst to further reduce NOₓ emissions. A particulate matter (“PM”) filter 806 receives exhaust gases from oxidation catalyst 808. Although oxidation catalyst 808 and PM filter 806 are shown as separate items, they may alternatively be combined into one package.

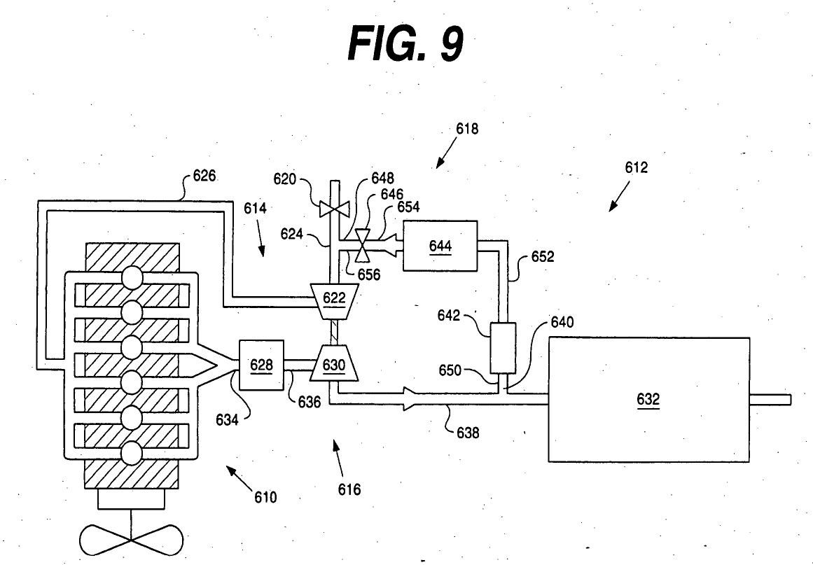

Further embodiments of PM filters are also shown in FIG. 9, which are further discussed in greater detail.

Some of the exhaust gases are delivered out the exhaust from the PM filter 806. However, a portion of exhaust gases are rerouted to the intake manifold 114 through an EGR cooler 810, through an EGR valve 812, and through first and second turbochargers 120,140. EGR cooler 810 may be of a type well known in the art, for example a jacket water or an air to gas heat exchanger type.

A means 816 for determining pressure within the PM filter 806 is shown. In the preferred embodiment, the means 816 for determining pressure includes a pressure sensor 818. However, other alternate means 816 may be employed. For example, the pressure of the exhaust gases in the PM filter 806 may be estimated from a model based on one or more parameters associated with the engine 110. Parameters may include, but are not limited to, engine load, engine speed, temperature, fuel usage, and the like.

A means 820 for determining flow of exhaust gases through the PM filter 806 may be used. Preferably, the means 820 for determining flow of exhaust gases includes a flow sensor 822. The flow sensor 822 may be used alone to determine pressure in the PM filter 806 based on changes in flow of exhaust gases, or may be used in conjunction with the pressure sensor 818 to provide more accurate pressure change determinations.

FIG. 9 illustrates a power source 610 having an exhaust treatment system 612. Power source 610 may include an engine such as, for example, a diesel engine, a gasoline engine, a natural gas engine, or any other engine apparent to one skilled in the art. Power source 610 may, alternately, include another source of power such as a furnace or any other source of power known in the art. Exhaust treatment system 612 may include an air induction system 614, an exhaust system 616, and a recirculation system 618.

Air induction system 614 may be configured to introduce charged air into a combustion chamber (not shown) of power source 610. Air induction system 614 may include a induction valve 620 and a compressor 622. It is contemplated that additional components may be included within air induction system 614 such as, for example, one or more air coolers, additional valving, one or more air cleaners, one or more waste gates, a control system, and other components known in the art.

Induction valve 620 may be fluidly connected to compressor 622 via a fluid passageway 624 and configured to regulate the flow of atmospheric air to power source 610. Induction valve 620 may be a spool valve, a shutter valve, a butterfly valve, a check valve, a diaphragm valve, a gate valve, a shuttle valve, a ball valve, a globe valve, or any other valve known in the art. Induction valve 620 may be solenoid actuated, hydraulically actuated, pneumatically actuated, or actuated in any other manner. Induction valve 620 may be in communication with a controller (not shown) and selectively actuated in response to one or more predetermined conditions.

Compressor 622 may be configured to compress the air flowing into power source 610 to a predetermined pressure. Compressor 622 may be fluidly connected to power source 610 via a fluid passageway 626. Compressor 622 may include a fixed geometry type compressor, a variable geometry type compressor, or any other type of compressor known in the art. It is contemplated that more than one compressor 622 may be included and disposed in parallel or in series relationship. It is further contemplated that compressor 622 may be omitted, when a non-pressurized air induction system is desired.

Exhaust system 616 may be configured to direct exhaust flow out of power source 610. Exhaust system 616 may include a first particulate filter 628, a turbine 630, and a second particulate filter 632. It is contemplated that additional emission controlling devices may be included within exhaust system 616.

Instead of the PM filter shown in FIG. 8, the exhaust system 616 may comprise a first particulate filter 628. Filter 628 may be connected to power source 610 via a fluid passageway 634 and to turbine 630 via a fluid passageway 636. First particulate filter 628 may include electrically conductive coarse mesh elements that have been sintered together under pressure. The mesh elements may include an iron-based material such as, for example, Fecralloy®. It is contemplated that mesh elements may also be implemented that are formed from an electrically-conductive material other than Fecralloy® such as, for example, a nickel-based material such as Inconel® or Hastelloy®, or another material known in the art. It is further contemplated that first particulate filter 628 may, alternately, include electrically non-conductive coarse mesh elements such as, for example, porous elements formed from a ceramic material or a high-temperature polymer.

First particulate filter 628 may include coarse mesh elements to reduce back-flow restriction within power source 610 that may adversely affect performance of power source 610. The mesh size of first particulate filter 628 may be such that the particulate-trapping efficiency of first particulate filter 628 is about 40% or less. It is contemplated that first particulate filter 628 may alternately have a particulate-trapping efficiency greater than 40%.

First particulate filter 628 may include either a catalyst to catalyze the particulate matter trapped by first particulate filter 628 (which may reduce an ignition temperature of the particulate matter), a means for regenerating the particulate matter trapped by first particulate filter 628, or both a catalyst and a means for regenerating. Because the catalyst included within first particulate filter 628 is immediately fluidly connected to power source 610, the catalyst may experience high temperatures that support reduction of hydrocarbons (“HC”), carbon dioxide (“CO”), and/or particulate matter. The catalyst may include, for example, a base metal oxide, a molten salt, and/or a precious metal that catalytically reacts with HC, CO, and/or particulate matter. The means for regeneration may include, among other things, a fuel-powered burner, an electrically resistive heater, an engine control strategy, or any other means for regenerating known in the art.

Turbine 630 may be connected to compressor 622 and configured to drive compressor 622. In particular, as the hot exhaust gases exiting power source 610 expand against the blades (not shown) of turbine 630, turbine 630 may rotate and drive connected compressor 622. It is contemplated that more than one turbine 630 may be included within exhaust system 616 and disposed in parallel or in series relationship. It is also contemplated that turbine 630 may, alternately, be omitted and compressor 622 be driven by power source 610 mechanically, hydraulically, electrically, or in any other manner known in the art.

In contrast to first particulate filter 628, second particulate filter 632 may be disposed downstream of turbine 630. Specifically, second particulate filter 632 may be fluidly connected to turbine 630 via a fluid passageway 638. Similar to first particulate filter 628, second particulate filter 632 may include electrically conductive mesh elements that have been sintered together under pressure. The mesh elements may include an iron-based material such as, for example, Fecralloy®. It is contemplated that mesh elements may also be implemented that are formed from an electrically-conductive material other than Fecralloy® such as, for example, a nickel-based material such as Inconel® or Hastelloy®, or another material known in the art. It is further contemplated that second particulate filter 632 may, alternately, include electrically non-conductive mesh elements such as, for example, porous elements formed from a ceramic material or a high-temperature polymer.

Second particulate filter 632 may include mesh elements having a smaller mesh size than the mesh elements of first particulate filter 628. The mesh size of second particulate filter 632 may be such that the particulate-trapping efficiency of second particulate filter 632 is about 80% or more. It is contemplated that the particulate-trapping efficiency of second particulate filter 632 may alternately be less than 80%.

Similar to first particulate filter 628, second particulate filter 632 may include either a catalyst, which may reduce an ignition temperature of the particulate matter trapped by second particulate filter 632, a means for regenerating the particulate matter trapped by second particulate filter 632, or both a catalyst and a means for regenerating. The catalyst may support reduction of HC, CO, and/or particulate matter. The catalyst may include, for example, a base metal oxide, a molten salt, and/or a precious metal. The means for regeneration may include, among other things, a fuel-powered burner, an electrically resistive heater, an engine control strategy, or any other means for regenerating known in the art.

Recirculation system 618 may be configured to redirect a portion of the exhaust flow of power source 610 from exhaust system 616 into air induction system 614. Recirculation system 618 may include an inlet port 640, a recirculation particulate filter 642, a cooler 644, a recirculation valve 646, and a discharge port 648.

Inlet port 640 may be connected to exhaust system 616 and configured to receive at least a portion of the exhaust flow from power source 610. Specifically, inlet port 640 may be disposed downstream from filter 628 and turbine 630 and upstream from second particulate filter 632. It is contemplated that inlet port 640 may be located elsewhere within exhaust system 616.

Recirculation particulate filter 642 may be connected to inlet port 640 via a fluid passageway 650 and configured to remove particulates from the portion of the exhaust flow directed through inlet port 640. Similar to first and second particulate filters 628, 632, recirculation particulate filter 642 may include electrically conductive coarse mesh elements that have been sintered together under pressure. The mesh elements may include an iron-based material such as, for example, Fecralloy®. It is contemplated that mesh elements may also be implemented that are formed from an electrically-conductive material other than Fecralloy® such as, for example, a nickel-based material such as Inconel® or Hastelloy®, or another material known in the art. It is further contemplated that recirculation particulate filter 642 may, alternately, include electrically non-conductive coarse mesh elements such as, for example, porous elements formed from a ceramic material or a high-temperature polymer.

Similar to first and second particulate filters 628, 632, recirculation particulate filter 642 may include either a catalyst, which may reduce an ignition temperature of the particulate matter trapped by recirculation particulate filter 642, a means for regenerating the particulate matter trapped by recirculation particulate filter 642, or both a catalyst and a means for regenerating. The catalyst may support reduction of HC, CO, and/or particulate matter. The catalyst may include, for example, a base metal oxide, a molten salt, and/or a precious metal. The means for regeneration may include, among other things, a fuel-powered burner, an electrically resistive heater, an engine control strategy, or any other means for regenerating known in the art. It is contemplated that recirculation particulate filter 642 may be omitted, if desired.

Cooler 644 may be fluidly connected to recirculation particulate filter 642 via a fluid passageway 652 and configured to cool the portion of the exhaust flowing through inlet port 640. Cooler 644 may include a liquid-to-air heat exchanger, an air-to-air heat exchanger, or any other type of heat exchanger known in the art for cooling an exhaust flow. It is contemplated that cooler 644 may be omitted, if desired.

Recirculation valve 646 may be fluidly connected to cooler 644 via fluid passageway 654 and configured to regulate the flow of exhaust through recirculation system 618. Recirculation valve 646 may be a spool valve, a shutter valve, a butterfly valve, a check valve, a diaphragm valve, a gate valve, a shuttle valve, a ball valve, a globe valve, or any other valve known in the art. Recirculation valve 646 may be solenoid actuated, hydraulically actuated, pneumatically actuated, or actuated in any other manner. Recirculation valve 646 may be in communication with a controller (not shown) and selectively actuated in response to one or more predetermined conditions.

A flow characteristic of recirculation valve 646 may be related to a flow characteristic of induction valve 620. Specifically, recirculation valve 646 and induction valve 620 may both be controlled such that an amount of exhaust flow entering air induction system 614 via recirculation valve 646 may be related to an amount of air flow entering air induction system 614 via induction valve 620. For example, as the flow of exhaust through recirculation valve 646 increases, the flow of air through induction valve 620 may proportionally decrease. Likewise, as the flow of exhaust through recirculation valve 646 decreases, the flow of air through induction valve 620 may proportionally increase.

Discharge port 648 may be fluidly connected to recirculation valve 646 via a fluid passageway 656 and configured to direct the exhaust flow regulated by recirculation valve 646 into air induction system 614. Specifically, discharge port 648 may be connected to air induction system 614 upstream of compressor 622, wherein compressor 622 draws the exhaust flow from discharge port 640.

### INDUSTRIAL APPLICABILITY

During use, the internal combustion engine 110 operates in a known manner using, for example, the diesel principle of operation. Referring to the air supply system shown in FIG. 1, exhaust gas from the internal combustion engine 110 is transported from the exhaust manifold 116 through the inlet duct 126 and impinges on and causes rotation of the turbine wheel 128. The turbine wheel 128 is coupled with the shaft 130, which in turn carries the compressor wheel 134. The rotational speed of the compressor wheel 134 thus corresponds to the rotational speed of the shaft 130.

The fuel supply system 200 and cylinder 112 shown in FIG. 2 may be used with each of the air supply systems 100, 300, 400. Compressed air is supplied to the combustion chamber 206 via the intake port 208, and exhaust air exits the combustion chamber 206 via the exhaust port 210. The intake valve assembly 214 and the exhaust valve assembly 216 may be controllably operated to direct airflow into and out of the combustion chamber 206.

In a conventional Otto or diesel cycle mode, the intake valve 218 moves from the second position to the first position in a cyclical fashion to allow compressed air to enter the combustion chamber 206 of the cylinder 112 at near top center of the intake stroke 406 (about 360° crank angle), as shown in FIG. 4. At near bottom dead center of the compression stroke (about 540° crank angle), the intake valve 218 moves from the first position to the second position to block additional air from entering the combustion chamber 206. Fuel may then be injector from the fuel injector assembly 240 at near top dead center of the compression stroke (about 720° crank angle).

In a conventional Miller cycle engine, the conventional Otto or diesel cycle is modified by moving the intake valve 218 from the first position to the second position at either some predetermined time before bottom dead center of the intake stroke 406 (i.e., before 540° crank angle) or some predetermined time after bottom dead center of the compression stroke 407 (i.e., after 540° crank angle). In a conventional late-closing Miller cycle, the intake valve 218 is moved from the first position to the second position during a first portion of the first half of the compression stroke 407.

The variable intake valve closing mechanism 238 enables the engine 110 to be operated in both a late-closing Miller cycle and a conventional Otto or diesel cycle. Further, injecting a substantial portion of fuel after top dead center of the combustion stroke 508, as shown in FIG. 5, may reduce NOₓ emissions and increase the amount of energy rejected to the exhaust manifold 116 in the form of exhaust fluid. Use of a high-efficiency turbocharger 320, 420 or series turbochargers 120, 140 may enable recapture of at least a portion of the rejected energy from the exhaust. The rejected energy may be converted into increased air pressures delivered to the intake manifold 114, which may increase the energy pushing the piston 212 against the crankshaft 213 to produce useable work. In addition, delaying movement of the intake valve 218 from the first position to the second position may reduce the compression temperature in the combustion chamber 206. The reduced compression temperature may further reduce NOₓ emissions.

The controller 244 may operate the variable intake valve closing mechanism 238 to vary the timing of the intake valve assembly 214 to achieve desired engine performance based on one or more engine conditions, for example, engine speed, engine load, engine temperature, boost, and/or manifold intake temperature. The variable intake valve closing mechanism 238 may also allow more precise control of the air/fuel ratio. By delaying closing of the intake valve assembly 214, the controller 244 may control the cylinder pressure during the compression stroke of the piston 212. For example, late closing of the intake valve reduces the compression work that the piston 212 must perform without compromising cylinder pressure and while maintaining a standard expansion ratio and a suitable air/fuel ratio.

The high pressure air provided by the air supply systems 100, 300, 400 may provide extra boost on the induction stroke of the piston 212. The high pressure may also enable the intake valve assembly 214 to be closed even later than in a conventional Miller cycle engine. In the present description, the intake valve assembly 214 may remain open until the second half of the compression stroke of the piston 212, for example, as late as about 80° to 70° before top dead center (“BTDC”). While the intake valve assembly 214 is open, air may flow between the chamber 206 and the intake manifold 114. Thus, the cylinder 112 experiences less of a temperature rise in the chamber 206 during the compression stroke of the piston 212.

Since the closing of the intake valve assembly 214 may be delayed, the timing of the fuel supply system may also be retarded. For example, the controller 244 may controllably operate the fuel injector assembly 240 to supply fuel to the combustion chamber 206 after the intake valve assembly 214 is closed. For example, the fuel injector assembly 240 may be controlled to supply a pilot injection of fuel contemporaneous with or slightly after the intake valve assembly 214 is closed and to supply a main injection of fuel contemporaneous with or slightly before combustion temperature is reached in the chamber 206. As a result, a significant amount of exhaust energy may be available for recirculation by the air supply system 100, 300, 400, which may efficiently extract additional work from the exhaust energy.

Referring to the air supply system 100 of FIG. 1, the second turbocharger 140 may extract otherwise wasted energy from the exhaust stream of the first turbocharger 120 to turn the compressor wheel 150 of the second turbocharger 140, which is in series with the compressor wheel 134 of the first turbocharger 120. The extra restriction in the exhaust path resulting from the addition of the second turbocharger 140 may raise the back pressure on the piston 212. However, the energy recovery accomplished through the second turbocharger 140 may offset the work consumed by the higher back pressure. For example, the additional pressure achieved by the series turbochargers 120, 140 may do work on the piston 212 during the induction stroke of the combustion cycle. Further, the added pressure on the cylinder resulting from the second turbocharger 140 may be controlled and/or relieved by using the late intake valve closing. Thus, the series turbochargers 120, 140 may provide fuel efficiency via the air supply system 100, and not simply more power

It should be appreciated that the air cooler 156, 356, 456 preceding the intake manifold 114 may extract heat from the air to lower the inlet manifold temperature, while maintaining the denseness of the pressurized air. The optional additional air cooler between compressors or after the air cooler 156, 356, 456 may further reduce the inlet manifold temperature, but may lower the work potential of the pressurized air. The lower inlet manifold temperature may reduce the NOₓ emissions.

Referring again to FIG. 8, a change in pressure of exhaust gases passing through the PM filter 806 results from an accumulation of particulate matter, thus indicating a need to regenerate the PM filter 806, i.e., burn away the accumulation of particulate matter. For example, as particulate matter accumulates, pressure in the PM filter 806 increases.

The PM filter 806 may be a catalyzed diesel particulate filter (“CDPF”) or an active diesel particulate filter (“ADPF”). A CDPF allows soot to burn at much lower temperatures. An ADPF is defined by raising the PM filter internal energy by means other than the engine 110, for example electrical heating, burner, fuel injection, and the like.

One method to increase the exhaust temperature and initiate PM filter regeneration is to use the throttle valve 814 to restrict the inlet air, thus increasing exhaust temperature. Other methods to increase exhaust temperature include variable geometry turbochargers, smart wastegates, variable valve actuation, and the like. Yet another method to increase exhaust temperature and initiate PM filter regeneration includes the use of a post injection of fuel, i.e., a fuel injection timed after delivery of a main injection.

The throttle valve 814 may be coupled to the EGR valve 812 so that they are both actuated together. Alternatively, the throttle valve 814 and the EGR valve 812 may be actuated independently of each other. Both valves may operate together or independently to modulate the rate of EGR being delivered to the intake manifold 114.

CDPFs regenerate more effectively when the ratio of NOₓ to particulate matter, i.e., soot, is within a certain range, for example, from about 20 to 1 to about 30 to 1. It has been found, however, that an EGR system combined with the above described methods of multiple fuel injections and variable valve timing results in a NOₓ to soot ratio of about 10 to 1. Thus, it may be desirable to periodically adjust the levels of emissions to change the NOₓ to soot ratio to a more desired range and then initiate regeneration. Examples of methods that may be used include adjusting the EGR rate and adjusting the timing of main fuel injection.

A venturi (not shown) may be used at the EGR entrance to the fresh air inlet. The venturi would depress the pressure of the fresh air at the inlet, thus allowing EGR to flow from the exhaust to the intake side. The venturi may include a diffuser portion that would restore the fresh air to near original velocity and pressure prior to entry into compressor 144. The use of a venturi and diffuser may increase engine efficiency.

An air and fuel supply system for an internal combustion engine in accordance with the embodiments of the description may extract additional work from the engine's exhaust. The system may also achieve fuel efficiency and reduced NOₓ emissions, while maintaining work potential and ensuring that the system reliability meets with operator expectations.

Referring now to FIG. 9, the disclosed exhaust treatment system may be applicable to any combustion-type device such as, for example, an engine, a furnace, or any other device known in the art where the recirculation of reduced-particulate gas into an air induction system is desired. Exhaust treatment system 612 may be a simple, inexpensive, and compact solution to reducing the amount of exhaust emissions discharged to the environment while protecting the combustion-type device from harmful particulate matter and/or poor performance caused by the particulate matter. The operation of exhaust treatment system 612 will now be explained.

Atmospheric air may be drawn into air induction system 614 via induction valve 620 to compressor 622 where it may be pressurized to a predetermined level before entering the combustion chamber of power source 610. Fuel may be mixed with the pressurized air before or after entering the combustion chamber. This fuel-air mixture may then be combusted by power source 610 to produce mechanical work and an exhaust flow containing gaseous compounds and solid particulate matter. The exhaust flow may be directed via fluid passageway 634 from power source 610 through first particulate filter 628, where a portion of the particulate matter entrained with the exhaust may be filtered out of the exhaust flow. Because first particulate filter 628 includes coarse mesh elements that may remove about 40% or less of the total particulate matter produced by power source 610, the increased back pressure due to first particulate filter 628 may be minimal.

The particulate matter, when deposited on the coarse mesh elements of first particulate filter 628 may be passively and/or actively regenerated. When passively regenerated, the particulate matter deposited on the coarse mesh elements may chemically react with a catalyst included within first particulate filter 628 to lower the ignition temperature of the particulate matter. Because first particulate filter 628 is located immediately downstream of the exhaust flow from power source 610, the temperatures of the exhaust flow entering first particulate filter 628 may be high enough, in combination with the catalyst, to facilitate passive regeneration. When actively regenerated, heat may be applied to the particulate matter deposited on the coarse mesh elements to elevate the temperature of the particulate matter to the ignition temperature of the trapped particulate matter. A combination of passive and active regeneration may include both catalytically lowering the ignition temperature of the particulate matter and applying heat to the mesh elements.

In addition to the particulate matter within the exhaust flow, HC and CO may also be partially catalyzed within first particulate filter 628. The high temperature exhaust being immediately directed to the catalyst of first particulate filter 638 may provide for sufficient catalytic conditions.

The flow of partially filtered exhaust from first particulate filter 628 coupled together with expansion of the hot exhaust gasses may cause turbine 630 to rotate, thereby rotating compressor 622 and compressing the inlet air. After exiting turbine 630, the exhaust gas flow may be divided into two flows, a first flow redirected to air induction system 614 and a second flow directed to second particulate filter 632.

As the exhaust flows through inlet port 640 of recirculation system 618, it may be filtered by recirculation filter 642 to remove additional particulate matter prior to communication with cooler 644. The particulate matter, when deposited on the mesh elements of recirculation particulate filter 642, may be passively and/or actively regenerated.

The flow of the reduced-particulate exhaust flow from recirculation particulate filter 642 may be cooled by cooler 644 to a predetermined temperature and then directed through recirculation valve 646 to be drawn back into air induction system 614 by compressor 622. The recirculated exhaust flow may then be mixed with the air entering the combustion chamber. As described above, the exhaust gas, which is directed to the combustion chamber, reduces the concentration of oxygen therein, which in turn lowers the maximum combustion temperature within the cylinder. The lowered maximum combustion temperature slows the chemical reaction of the combustion process, thereby decreasing the formation of nitrous oxides. In this manner, the gaseous pollution produced by power source 610 may be reduced without experiencing the harmful effects and poor performance caused by excessive particulate matter being directed into power source 610.

The ratio of cooled and reduced-particulate exhaust from recirculation system 618 relative to inlet air may be regulated by recirculation valve 646 and induction valve 620. As described above, the flow position of recirculation valve 646 and induction valve 620 may be related. As the flow of inlet air into power source 610 via induction valve 620 increases, the flow of cooled reduced-particulate exhaust into power source 610 decreases. Similarly, as the flow of inlet air into power source 610 via induction valve 620 decreases, the flow of cooled reduced-particulate exhaust into power source 610 increases.

As the second flow of exhaust leaves turbine 630, it may be filtered by second particulate filter 632 to remove additional particulate matter. Similar to first particulate filter 628 and recirculation filter 642, second particulate filter 632 may also be passively and/or actively regenerated to reduce the amount of HC, CO, and/or particulate matter exhausted to the atmosphere.

It will be apparent to those skilled in the art that various modifications and variations can be made in the disclosed air and fuel supply system for an internal combustion engine without departing from the scope or spirit of the description. Other embodiments will be apparent to those skilled in the art from consideration of the specification and practice disclosed herein. It is intended that the specification and examples be considered as exemplary only.

1. A method of operating an internal combustion engine including at least one cylinder and a piston slidable in the cylinder, the method comprising:
supplying a mixture of pressurized air and recirculated exhaust gas from an intake manifold to an air intake port of a combustion chamber in the cylinder;
operating an air intake valve to open the air intake port to allow the pressurized air and exhaust gas mixture to flow between the combustion chamber and the intake manifold during a portion of a compression stroke of the piston; and
filtering particulate matter from an exhaust stream of the engine with a particulate filter.

2-26. (canceled)
